(19) United States
(12) Patent Application Publication
(10) Pub. No.: US 2012/0063943 A1
(43) Pub. Date: Mar. 15, 2012

(54) METAL COMPOSITE POWDER, SINTERED BODY, AND PREPARATION METHOD THEREOF

(75) Inventor: Shinhoo Kang, Seoul (KR)

(73) Assignee: SNU R&DB FOUNDATION, Seoul (KR)

(21) Appl. No.: 13/321,272

(22) PCT Filed: Sep. 28, 2009
(86) PCT No.: PCT/KR2009/005529

§ 371 Date: Nov. 18, 2011

(30) Foreign Application Priority Data
May 21, 2009 (KR) 10-2009-0044256

(51) Int. Cl. B22F 1/00; B22F 3/10; B22F 3/12; B32B 15/02; B22F 3/105

(52) U.S. Cl. 419/13; 75/238; 75/241; 75/236; 419/14

(57) ABSTRACT

Provided are a composite powder of a metal and carbide (carbonitride) for a structural material, a sintered body, and methods of preparing the composite powder and sintered body. The composite powder for a structural member has a composition of M₁₋ₓ % M₂C, M₁₋ₓ % (M₂,M₁)C, M₁₋ₓ % M₂(CN), or M₁₋ₓ % (M₂,M₁)(CN). A matrix-phase metal M₁ is one selected from tungsten (W) and molybdenum (Mo) of the periodic table of the elements, an accessory-phase metal M₂ is one selected from the group consisting of Group-IV to Group-VI metals of the periodic table of the elements and forms a carbide or carbonitride having an average particle size of about 1 μm or less, and the matrix-phase metal M₁ and the accessory-phase metal M₂ coexist due to a reaction.

### TECHNICAL FIELD

The present disclosure relates to a composite powder of a metal and carbide (or carbonitride) for a structural material, a sintered body, and a method of preparing the same. More specifically, the present disclosure relates to a composite powder of a metal and carbide (or carbonitride) for a structural material, a sintered body, and methods of preparing the composite powder and sintered body.

### BACKGROUND ART

Tungsten (W) and molybdenum (Mo) having high melting points of 3680 K and 2890 K and high Young's moduli are widely used as high-temperature application materials. However, since W and Mo have problems in that W and Mo crystal structures cause low toughness, a high-temperature oxidation, and degradation in high-temperature physical properties, Group-IV to Group-VI carbide ceramics are being added to conventional super-heat-resistant alloys to enable grain boundary strengthening. The carbides are materials having characteristics such as high melting points, hardnesses, thermal conductivities, electrical conductivities, and chemical stability, and it is known that the carbides have very high melting points, solid-phase thermodynamic stability, and thermomechanical and thermochemical properties.

Zirconium carbide (ZrC) and hafnium carbide (HfC) have attracted attention as typical additive carbides for grain boundary strengthening. ZrC, which is a cubic system (NaCl-type) among metal-carbide compounds, is being used as a high-temperature structural material, a superhard material, or a composite material due to its high melting point (about 3420° C.), high hardness (micro-hardness of about 2600 Kg/mm²), and good heat and impact resistances. HfC is being used as a composite material having the same uses as ZrC due to its high melting point (about 3928° C.), high hardness (micro-hardness of about 2700 Kg/mm²), and heat and impact resistances.

HfC and ZrC powder, which are the next-generation materials to be applied to matrix metals, such as W and Mo, which are employed at ultrahigh temperatures, require a stable particle size of about several μm or less. This is because, as the particle size of the powder decreases, grain growth or coalescence caused by a contact of carbide within a microstructure may be prevented more effectively, particles may be dispersed more uniformly, and oxidation resistance and high-temperature intensity may increase. A heat-resistant metal composite sintered body having improved thermal and mechanical properties in the above-described manner may be broadly utilized as a heat-resistance material for ultrasonic airplanes or heat sinks for astronautic boosting propellers.

A method of preparing a composite sintered body for a structural material using a conventional technique includes mixing a matrix-phase metal powder, such as W and Mo, with a carbide or carbonitride powder prepared using additional reduction and carbonization processes, shaping the mixture, and sintering the mixture at a high temperature under a high pressure using a hot press or a hot isostatic press (HIP).

Research on preparation of carbides has been in progress for a long time. In particular, in manufacture of ZrC carbide, various synthesizing methods have been reported since Troost synthesized ZrC from ZrO₂ and C in 1865 for the first time. Although a synthesizing method using ZrO₂ as a start material uses a low reaction temperature, it is difficult to completely remove oxygen (O). A method using ZrH instead of ZrO₂, which was taught by Norton and Lewis to solve the above-described problem, requires a high reaction temperature of about 2200° C. and involves causing a reaction in a vacuum [refer to J. of Materials Processing Technology 175 (2006) 364-375, Materials Sci. & Eng. A 497 (2008) 79-86].

Although there was interest in a reaction among ZrCl₄, H₂, and hydrocarbon vapor developed by Campbell, the reaction requires a high reaction temperature of about 1730° C. to 2430° C. and capturing a synthesized powder is difficult. Thus, a process of putting additives, such as CaCO₃ and MgO₂, to aid reduction of ZrO₂ and HfO₂ has been studied [refer to Material Chemistry and Physics 74 (2002) 272-281].

In another approach, due to ongoing demands for a method of reducing a particle size of the carbide to solve grain growth caused by a high reduction temperature or an increase in particle size due to carbide combination after high-temperature synthesis, research on synthesis of ZrC having a nanoscale particle size has been reported [refer to J. of Materials Science 39 (2004) 6057-6066].

Furthermore, only fundamental research is being conducted on stability or physical properties of hafnium carbide (HfC). For example, results of research on reactivity of Hf of each of HfC, hafnium boron (HfB), and hafnium nitride (HfN) [J. of Materials Science 39 (2004) 6023-6042] and results of research on the mechanical and thermal properties of each of HfC, HfB, and HfN. [J. of Materials Science 39 (2004) 5939-5949] have been reported.

In general, reports of research on HfC and ZrC powder are limited and furthermore, results of preparation and application of a hyperfine powder are being obtained within controlled ranges for strategic reasons. In 1995, Dowcorning, Japan, prepared a ZrC ceramic sintered body using a polymer as a binder and applied for a patent (AU2720995) on the preparation technique. In 1996, Dowcorning invented a method of preparing a high-density ZrC ceramic sintered body and applied for a patent (JP1996-109066 entitled “ZrC sintered body and method of preparing the same) on the method. In 1996, Dowcorning applied for a patent (KR1996-0007500) on a method of preparing a high-density ZrC ceramic compact. The method includes mixing ZrC powder with a preliminary ceramic organic silicon (Si) polymer and shaping and sintering the mixture under pressure or without pressure.

In 2002, Sanyo Special Steel Co., Ltd. developed a technique of simultaneously preparing and dispersing a composite metal powder and applied for a patent thereon. This application discloses a method of preparing a carbide composite powder containing a matrix-phase metal, which includes mixing several high-hardness carbides with a fusion metal, such as nickel (Ni), cobalt (Co), or iron (Fe), and atomizing the mixture in a gas state (JP2002-371403 entitled “Method of preparing composite metal powder”).

As explained thus far, it can be known that research and patents on the corresponding field are limited to preparation of each of carbide powders and carbide sintered bodies. Accordingly, the current technique relates to a method of preparing a heat-resistant metal composite sintered body, which includes preparing a matrix-phase metal powder and a carbide or carbonitride powder using separate processes at a high temperature of about 2000° C. to about 2200° C., mixing the matrix-phase metal powder with the carbide or carbonitride powder, shaping the mixture, and sintering the mixture at a high temperature under a high pressure. However, in the resultant sintered body, segregation of carbide (or carbonitride) in the mixture powder, which is regarded as the limit of the mixing process, has caused grain growth or grain combination of carbide (or carbonitride). Thus, it has been difficult to control the size of the carbide and obtain a uniformly dispersed microstructure. As a result, an improvement in the properties of the sintered body has always been restricted.

### DISCLOSURE

### Technical Problem

The present disclosure provides a method of preparing a composite powder by which a metal/ceramic composite powder in which a carbide (or a nitride) is uniformly dispersed in a matrix-phase metal may be prepared using a one-step reaction process including reaction and carbonization (or carbonitridation) of composite oxides without an additional mixing process. Also, the present disclosure provides a sintered body obtained by uniformly dispersing a carbide or carbonitride having an average particle size of several μm or less within a microstructure of the sintered body using the composite powder. The metal composite sintered body prepared using the above-described method may greatly improve physical properties, such as toughness, high-temperature intensity, high-temperature heat resistance, and oxidation resistance.

Therefore, as compared with a conventional technique in which a conventional oxide is mixed with carbon (C) and thermally treated at a high temperature for a long time to prepare a carbide (or carbonitride) and the carbide (or carbonitride) is mixed with a matrix-phase metal (tungsten (W), molybdenum (Mo), titanium (Ti), tantalum (Ta), or niobium (Nb)) prepared using another process to obtain a sintered body, a method according to the present disclosure in which a composite powder for a heat-resistant structural material is directly prepared using a mixture of a metal oxide ground at a high energy as a start material, and a sintered body which is obtained from the powder requires a simple preparation process and is economical and requires a low process temperature so that C powder can have a small crystal grain size and dispersion of the carbide (or carbonitride) in the sintered body can be facilitated to obtain a uniform microstructure.

However, a technique of preparing a sintered body that may be commercially produced in large quantities, performed at a low process temperature using a high-energy grinding process, produce small crystal grains of carbide powder, adopt a simple preparation process, and facilitate dispersion of carbide (or carbonitride) in the sintered body to provide a uniform microstructure has neither been developed nor proposed thus far.

According to an exemplary embodiment, composite powder for a structural material is provided. The composite powder has a composition of M₁₋ₓ % M₂C, M₁₋ₓ % (M₂,M₁)C, M₁₋ₓ % M₂(CN), or M₁₋ₓ % (M₂,M₁)(CN). Herein, a matrix-phase metal M₁ is one selected from tungsten (W) and molybdenum (Mo) of the periodic table of the elements, an accessory-phase metal M₂ is one selected from the group consisting of Group-IV to Group-VI metals of the periodic table of the elements and forms a carbide or carbonitride having an average particle size of about 1 μm or less, and the matrix-phase metal M₁ and the accessory-phase metal M₂ coexist due to a reaction.

According to another exemplary embodiment, a method of preparing a composite powder for a structural material is provided. The method includes i) mixing or mixing and grinding at least one material selected from the group consisting of a single metal M₁, which is W or Mo, and an oxide, carbides and nitrides of the metal M₁, at least one material selected from the group consisting of at least one metal M₂ selected from the group consisting of Group-IV to Group-VI metal elements of the periodic table of the elements and an oxide and a nitride of the metal M₂, and C powder; and ii) causing reduction and carbonization or reduction and carbonitridation by heating the mixture of step i).

According to another exemplary embodiment, a composite sintered body for a structural material is provided. The composite sintered body is obtained by coupling a matrix-phase metal M₁ selected from W and Mo with an accessory-phase metal (M₂)-based carbide or carbonitride selected from Group-IV to Group-VI elements of the periodic table of the elements.

According to another exemplary embodiment, a method of preparing a composite sintered body for a structural material is provided. The method includes i) mixing or mixing and grinding at least one material selected from the group consisting of a single metal M₁ and an oxide, a carbide, and a nitride of the metal M₁, at least one material selected from the group consisting of at least one metal M₂ selected from the group consisting of Group-IV to Group-VI metals of the periodic table of the elements and an oxide and a nitride of the metal M₂, and C powder; ii) causing reduction and carbonization or reduction and carbonitridation by heating the mixture of step i); iii) mixing a powder obtained in step ii) with a powder of the metal M₁ as needed; and iv) shaping and sintering the powder obtained in step ii) or step iii).

### Technical Solution

One aspect of the present invention provides a composite powder for a structural material having a composition of M₁₋ₓ % M₂C, M₁₋ₓ % (M₂,M₁)C, M₁₋ₓ % M₂(CN), or M₁₋ₓ % (M₂,M₁)(CN), wherein a matrix-phase metal M₁ is one selected from tungsten (W) and molybdenum (Mo) of the periodic table of the elements, an accessory-phase metal M₂ is one selected from the group consisting of Group-IV to Group-VI metals of the periodic table of the elements and forms a carbide or carbonitride having an average particle size of about 1 μm or less, and the matrix-phase metal M₁ and the accessory-phase metal M₂ coexist due to a reaction.

The composite powder may include a single metal phase M₁, which is W or Mo, and comprises at least two phases, which are carbides M₂C and (M₂,M₁)C or carbonitrides M₂(CN) and (M₂,M₁)(CN).

The metal M₁ may be preferably selected from W and Mo and one selected from the group consisting of titanium (Ti), vanadium (V), chromium (Cr), zirconium (Zr), niobium (Nb), hafnium (Hf), and tantalum (Ta). Also, a powder of the carbide or carbonitride may have crystal grains with a size of about 30 nm to 100 nm and particle aggregates with a size of about 1 μm to 2 μm.

Another aspect of the present invention provides a method of preparing a composite powder for a structural material, including: i) mixing or mixing and grinding at least one material selected from the group consisting of a single metal M₁, which is W or Mo, and an oxide, carbides and nitrides of the metal M₁, at least one material selected from the group consisting of at least one metal M₂ selected from the group consisting of Group-IV to Group-VI metal elements and an oxide and a nitride of the metal M₂, and C powder; and ii) causing reduction and carbonization or reduction and carbonitridation by heating the mixture of step i).

In the method of preparing a composite powder for a structural material, at least one metal M₂ other than W or Mo may be preferably one selected from Zr and Hf and may be one selected from the group consisting of Ti, V, Cr, Nb, and Ta.

The grinding process of step i) may be performed using a high-energy milling apparatus, such as a Z-mill, a jet mill, a beads mill, an attrition, a planetary mill, or a cryomill. The grinding process may be performed according to the size of powder of prepared raw materials. Accordingly, the carbide or carbonitride powder obtained in step ii) may have crystal grains with a size of about 30 nm to about 100 nm and particle aggregates with a size of about 1 μm to 2 μm.

In the method of preparing the composite powder for the structural material, the heating of the mixture in step ii) may be performed at a temperature of preferably about 1100° C. to about 2200° C., more preferably about 1300° C. to about 1700° C. Also, the heating of the mixture in step ii) may be performed for about 0.5 hour to about 5 hours.

The heating of the mixture in step ii) may be performed in the atmosphere of hydrogen (H2) or nitrogen (N2). Also, the heating of the mixture in step ii) may be performed in a vacuum.

The composite powder may include the single metal phase M₁ and include at least two phases, which are carbides M₂C and (M₂,M₁)C or carbonitrides M₂(CN) and (M₂,M₁)(CN).

The carbide or carbonitride of the composite powder may have an average particle size of about 1 μm or less.

The composite powder prepared using the method of preparing a composite powder for a structural material according to the present invention may contain 60 mol % or less of the main-phase metal M₁.

Another aspect of the present invention provides a composite sintered body for a structural material, which is obtained by coupling a matrix-phase metal M₁ selected from W and Mo with an accessory-phase metal (M₂)-based carbide or carbonitride selected from Group-IV to Group-VI elements of the periodic table of the elements.

The composite sintered body may contain about 40% to about 95% by volume the matrix-phase metal M₁.

In addition, the accessory-phase carbide or carbonitride may have an average particle size of about 1 μm to 2 μm.

The accessory-based carbide and carbonitride may be M₂C and (M₂,M₁)C or M₂(CN) and (M₂,M₁)(CN), which have face-centered cubic (FCC) structures. Each of the main-phase metal M₁ and the accessory-phase metal M₂ is one selected from the group consisting of Ti, V, Cr, Zr, Nb, Mo, Hf, W, and Ta.

In addition, the accessory-based metal may further include an additive (e.g., titanium carbide (TiC), titanium nitride (TiN), Ti(CN), ZrC, molybdenum carbide (MoC), Mo₂C, Cr₂C₃, VC, boron carbide (B₄C), BN, SiC, and Si₃N₄) selected from the group consisting of carbides, nitrides, and carbonitrides of one selected from Group-IV to Group-VI metals of the periodic table of the elements. Also, the accessory-based metal may contain about 0.1 to 30% by volume the additive within the sintered carbide.

Another aspect of the present invention provides a method of preparing a composite sintered body for a structural material. The method includes i) mixing or mixing and grinding at least one material selected from the group consisting of a single metal M₁ and an oxide, a carbide, and a nitride of the metal M₁, at least one material selected from the group consisting of at least one metal M₂ selected from the group consisting of Group-IV to Group-VI metals of the periodic table of the elements and an oxide and a nitride of the metal M₂, and C powder; ii) causing reduction and carbonization or reduction and carbonitridation by heating the mixture of step i); iii) mixing a powder obtained in step ii) with a powder of the metal M₁ as needed; and iv) shaping and sintering the powder obtained in step ii) or step iii).

In step i) of the method, M₁ may be one selected from the group consisting of Ti, V, Cr, Zr, Nb, Hf, and Ta.

In step ii) of the method, the heating of the mixture may be performed at a temperature of preferably about 1100° C. to 2200° C., more preferably about 1300° C. to about 1700° C. Also, the heating of the mixture in step ii) may be performed for about 0.5 hour to about 5 hours.

Furthermore, the heating of the mixture in step ii) may be performed in the of H2 or N2. Also, the heating of the mixture in step ii) may be performed in a vacuum.

The composite powder obtained in step ii) may include a single metal phase

M₁ and include at least two phases, which are carbides M₂C and (M₂,M₁)C or carbonitrides M₂(CN) and (M₂,M₁)(CN).

The carbide or carbonitride powder obtained in step ii) may have crystal grains with a size of about 30 nm to 100 nm and particle aggregates with a size of about 1 μm to 2 μm.

In step iii), powder of the metal M₁ may be added to and mixed with the composite powder obtained in step ii) according to needed properties and compositions.

The sintering of the powder in step iv) may be performed in the atmosphere of N2 or Argon (Ar) or in vacuum using a hot press process, a hot isostatic press (HIP) process, a gas pressure sintering (GPS) process, or a spark plasma sintering (SPS) process at a temperature of about 1000° C. to about 2200° C. for about 0.5 hour to about 2 hours. Furthermore, the powder may be heated by raising temperature at a heating rate of about 1° C./min to about 20° C./min up to the sintering temperature.

In step iv) of the method, the composite powder obtained in step ii) or iii) may be shaped so that a hot press process, an HIP process, a GPS process, or an SPS process may be further applied to presintered bodies.

In step iv), the hot press process may be performed at a temperature of about 1700° C. to 2200° C. according to a used pressure under a pressure of about 0.1 MPa to about 100 MPa. Also, the HIP process may be performed at a temperature of about 1000° C. to 2200° C. according to a used pressure under a pressure of about 10 MPa to about 150 MPa in the atmosphere of N2 or Ar.

After the sintering process of step iv), a composite sintered body for a structural material in which the accessory-phase carbide or carbonitride has an average particle size of about 1 μm or less may be prepared.

In the method of preparing the composite sintered body according to the present invention, the mixture powder obtained in step ii) or iii) may further include an additive (e.g., TiC, TiN, Ti(CN), ZrC, MoC, Mo₂C, Cr₂C₃, VC, B₄C, BN, SiC, and Si₃N₄) selected from the group consisting of carbides, nitrides, and carbonitrides of one selected from Group-IV to Group-VI metals of the periodic table of the elements. The mixture powder obtained in step i) may contain about 0.1% by weight the additive to 30% by volume the additive.

### Advantageous Effect

According to conventional techniques, since a mixture powder for a structural material is prepared by mixing a matrix-phase metal powder and a carbide or carbonitride powder prepared using separate processes, it is easy to segregate a carbide or carbonitride in the mixture powder. Therefore, when the mixture powder is shaped and sintered, a grain combination of the carbide (or carbonitride) segregated in the sintered body has occurred, causing serious grain growth and precluding preparation of a uniformly dispersed microstructure. Thus, an improvement in the properties of the mixture powder is restricted.

According to the present invention, a composite powder for a structural material may be prepared using a one-step process including a simultaneous reaction process of composite oxides without an additional mixing process. Also, since the present invention provides a metal/ceramic composite powder in which a carbide (or carbonitride) is uniformly dispersed in a matrix-phase metal, a sintered-compact microstructure in which a sub-micrometer carbide or carbonitride is uniformly dispersed may be provided after a sintering process, physical properties such as toughness, high-temperature intensity, high-temperature heat resistance, and oxidation resistance may be greatly improved.

### BRIEF DESCRIPTION OF DRAWINGS

FIG. 1 is a graph showing X-ray diffraction (XRD) results of a W-30 mol. % ZrC powder prepared due to reduction and carbonization under conditions of (a) 1300° C. (2 hours), (b) 1400° C. (2 hours), (c) 1500° C. (2 hours), and (d) 1600° C. (1 hour).

FIG. 2 is a graph showing XRD results of a W-50 mol. % ZrC powder prepared due to reduction and carbonization under conditions of (a) 1300° C. (2 hours), (b) 1400° C. (2 hours), (c) 1500° C. (2 hours), and (d) 1600° C. (1 hour).

FIG. 3 is a graph showing XRD results of a W-70 mol. % ZrC powder prepared due to reduction and carbonization under conditions of (a) 1400° C. (2 hours), (b) 1500° C. (2 hours), and (c) 1600° C. (1 hour).

FIG. 4 is a scanning electronic microscope (SEM) image of a microstructure of a W-30ZrC powder sintered body obtained by sintering a W-xZrC structural-material composite powder, which is prepared by performing reduction and carbonization at a temperature of about 1500° C. for 2 hours, at a temperature of about 1900° C. for 1 hour under a pressure of about 10 MPa in a hot press.

FIG. 5 is a SEM image of a microstructure of a W-70ZrC powder sintered body obtained by sintering a W-xZrC structural-material composite powder, which is prepared by performing reduction and carbonization at a temperature of about 1500° C. for 2 hours, at a temperature of about 1900° C. for 1 hour under a pressure of about 10 MPa in a hot press.

FIG. 6 is a graph showing XRD analysis results of a W-50ZrC powder prepared by performing reduction and carbonization at a temperature of about 1600° C. for about 1 hour.

FIG. 7 is a graph showing XRD analysis results of a W-68 mol. % ZrC_{0.47} powder prepared by performing reduction and carbonization at a temperature of about 1500° C. for about 1 hour.

FIG. 8 is a graph showing XRD analysis results of W-50Zr(CN) prepared by performing reduction and carbonitridation at a temperature of about 1500° C. for about 2 hours.

FIG. 9 is a SEM image of a microstructure of a Mo-30 mol. % ZrC powder sintered body obtained by sintering a Mo-30 mol. % ZrC structural-material composite powder, which is prepared by performing reduction and carbonization at a temperature of about 1500° C. for 1 hour, and at a temperature of about 2000° C. for 1 hour under a pressure of about 10 MPa in a hot press.

### MODE FOR EMBODYING INVENTION

The disclosure is described more fully hereinafter with reference to the accompanying drawings, in which embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

### Embodiment 1

To prepare a composite powder for a W-xZrC (x=30, 50, 70 mol. %) heat-resistant structural material, tungsten trioxide (WO₃), zirconium dioxide (ZrO₂), and carbon (C) powder were prepared as shown in Table 1. In this case, in view of the fact that a reduction process is mostly carried out due to emission of CO gas, the amount of injected C was determined by calculating that 3 mol of C per 1 mol of WO₃ and 3 mol of C per 1 mol of ZrO₂ were required to prepare carbide using WO₃.

TABLE 1

| Target composition | Used raw materials (gram/batch) | | |
|---|---|---|---|
| (mol. %) | ZrO₃ | WO₃ | C |
| W-30ZrC | 3.943 | 17.227 | 3.83 |
| W-50ZrC | 7.189 | 13.596 | 4.215 |
| W-70ZrC | 11.249 | 9.054 | 4.697 |

The prepared mixture of materials was dry ground by means of a high-energy planetary mill using WC—Co balls at a rate of 250 rpm and a ball-to-power ratio (BPR) of about 40:1 for about 20 hours and thermally treated in a vacuum at a temperature of about 1300° C. to about 1500° C. for 2 hours or at a temperature of about 1600° C. for 1 hour and underwent reduction and carbonization processes to prepare a powder.

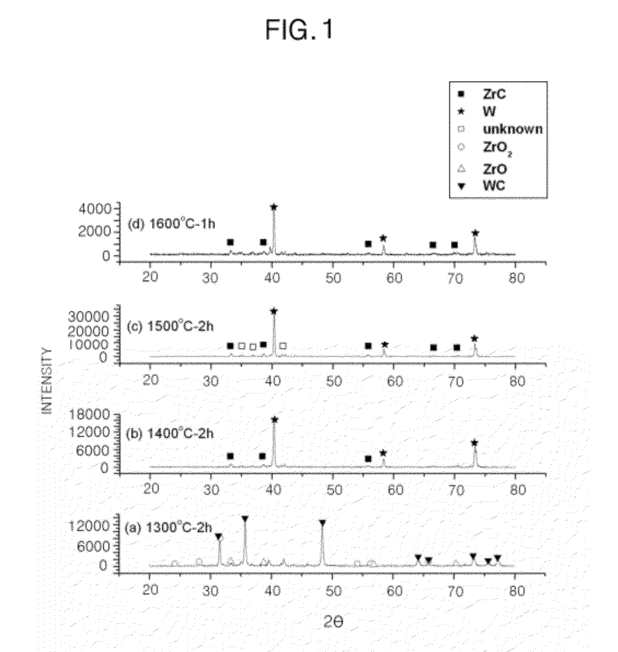

FIG. 1 is a graph showing X-ray diffraction (XRD) results of a W-30 mol. % ZrC powder prepared due to reduction and carbonization under conditions of (a) 1300° C. (2 hours), (b) 1400° C. (2 hours), (c) 1500° C. (2 hours), and (d) 1600° C. (1 hour).

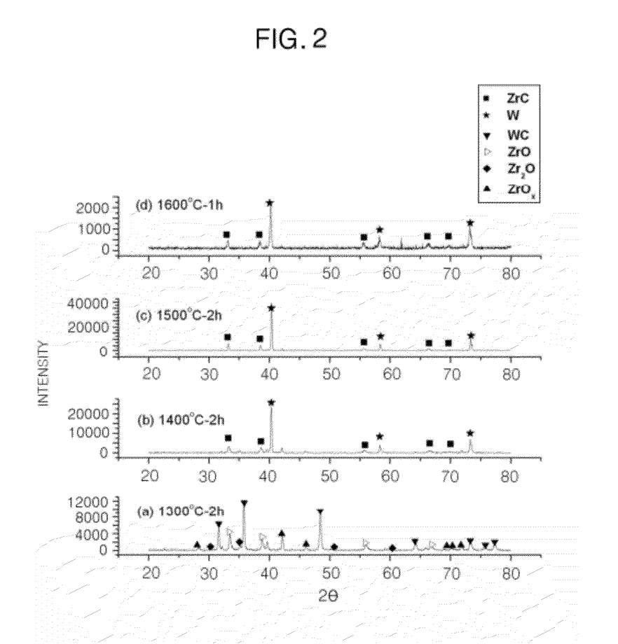

FIG. 2 is a graph showing XRD results of a W-50 mol. % ZrC powder prepared due to reduction and carbonization under conditions of (a) 1300° C. (2 hours), (b) 1400° C. (2 hours), (c) 1500° C. (2 hours), and (d) 1600° C. (1 hour).

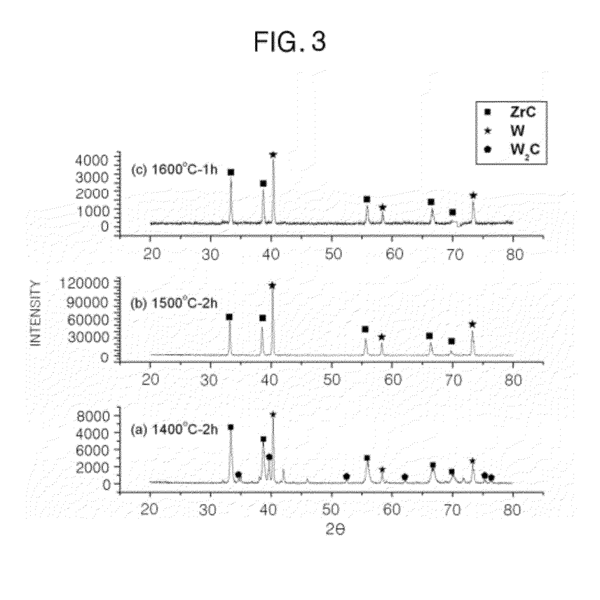

FIG. 3 is a graph showing XRD results of a W-70 mol. % ZrC powder prepared due to reduction and carbonization under conditions of (a) 1400° C. (2 hours), (b) 1500° C. (2 hours), and (c) 1600° C. (1 hour).

From the results shown in FIGS. 1 through 3, it can be seen that an oxide powder prepared using the same composition and grinding method formed different phases according to reduction and carbonization temperatures and times. That is, it can be seen that as temperatures at which the ground powder was reduced and carbonized increased or times for which the ground powder was reduced and carbonized increased, the amount of an intermediate phase including W₂C and WC decreased, while complete preparation of a W-xZrC composite powder having a desired composition was enabled. When the reduction and carbonization temperatures are low, the times for which the ground powder was reduced and carbonized may be relatively extended to enable preparation of W-xZrC; while when the reduction and carbonization temperature are high, the reduction and carbonization times may be reduced (e.g., about 1600° C. and 1 hour).

In addition, formation of the intermediate phase, such as W₂C, may be enabled by controlling the amount of added C and the grinding extent of the high-energy mill process.

Furthermore, from the results of FIGS. 2 and 3, it can be seen that when mol % of ZrC was equal to or higher than mol % of W, the formation of the intermediate phase could be effectively controlled. Also, by observing a variation in lattice constant, it can be seen that the phase transition from Zr(C,O) to ZrC occurred with a rise in reduction temperature. That is, the amount of 0 in ZrC was reduced. Table 2 shows 2q angles of ZrO, ZrC, and ZrN having FCC structures listed by the Joint Committee on Power Diffraction Standards (JCPDS), which are required for power XRD analysis, along with 2q angles of W having a body-centered cubic lattice (BCC) structure, and shows formation of Zr(C,O).

TABLE 2

| | Standard Peak Position (2θ) | | | |
|---|---|---|---|---|
| Peaks | ZrO | ZrC | ZrN | W |
| 1^{st} | 33.56(111) | 33.07(111) | 33.92(111) | 40.3(110) |
| 2^{nd} | 38.94(200) | 38.37(200) | 39.36(200) | 58.33(200) |
| 3^{rd} | 56.27(220) | 55.38(220) | 56.89(220) | 73.27(211) |

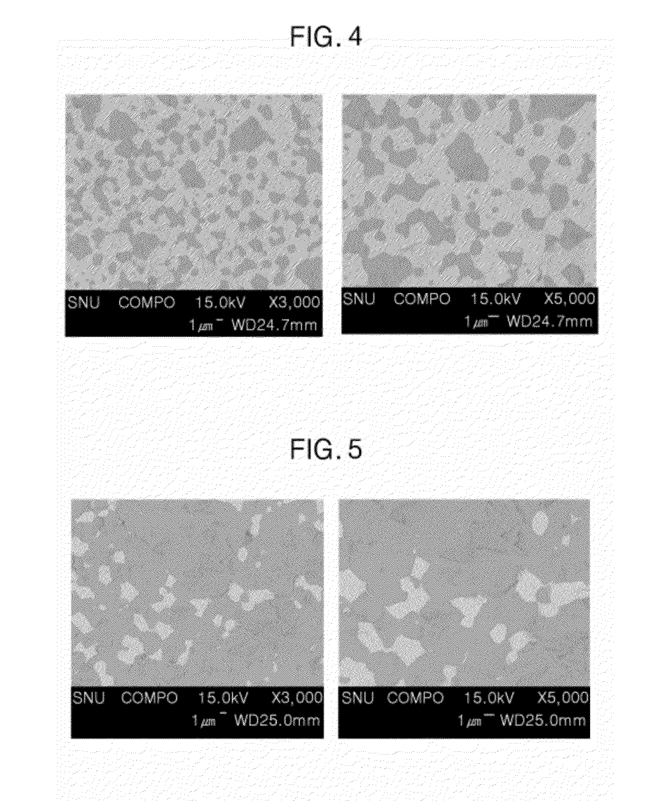

FIG. 4 is a scanning electronic microscope (SEM) image of a microstructure of a W-30ZrC powder sintered body obtained by sintering a W-xZrC structural-material composite powder, which is prepared by performing reduction and carbonization at a temperature of about 1500° C. for 2 hours, at a temperature of about 1900° C. for 1 hour under a pressure of about 10 MPa in a hot press, according to Embodiment 1. FIG. 5 is a SEM image of a microstructure of a W-70ZrC powder sintered body.

Grain growth or grain combination of the carbide (dark color) already started to occur in the W-30ZrC sintered body. The carbide grains reached the average particle size of about 1 μm to 2 μm and spread uniformly. The grain combination with a size of about 3 μm to about 4 μm occurred. When the amount of ZrC reached 70 mol. %, it was observed that most carbide particles were combined with one another.

### Embodiment 2

To prepare a W-50 mol. % ZrC powder, tungsten carbide (WC), zirconium dioxide (ZrO₂), and C powder were prepared as shown in Table 3. In this case, in view of the fact that a reduction process is mostly carried out due to emission of CO gas, 2 mol of C per 1 mol of ZrO₂ was used, and a composition of prepared materials was determined such that ZrC was generated due to carbonization between added WC and reduced Zr.

TABLE 3

| Target composition | Raw materials used (gram/batch) | | |
|---|---|---|---|
| (mol. %) | ZrO₂ | WC | C |
| W-50ZrC | 14.586 | 8.0 | 5.657 |

The prepared mixture of materials was dry ground by means of a high-energy planetary mill using WC—Co balls at a rate of 250 rpm and a BPR of about 30:1 for about 20 hours and thermally treated in a vacuum at a temperature of about 1500° C. for 1 hour and underwent reduction and carbonization processes to prepare a composite powder for a structural material.

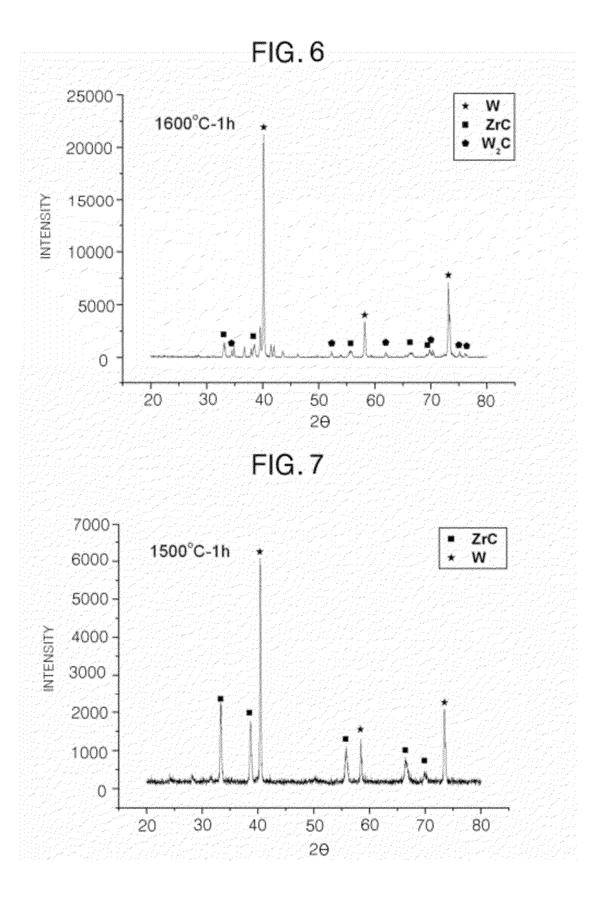

FIG. 6 is a graph showing XRD analysis results of a W-50ZrC powder prepared by performing reduction and carbonization at a temperature of about 1600° C. for about 1 hour.

In view of the fact that W₂C was also formed despite the reduction and carbonization of the ground powder at a temperature of about 1600° C. for 1 hour, it may be inferred that a large amount of C was used. When the above-described composition is used intact and reduction and carbonization temperatures are raised up to about 1700° C. to about 1800° C. or a reduction time is increased, W-50 mol. % ZrC is expected to be formed. However, W-W2C—ZrC other than W-50 mol. % ZrC may be used according required hardness or physical properties.

### Embodiment 3

To prepare a W-68 mol. % ZrC_{0.47} nonstoichiometric carbide powder, WC, ZrO₂, and C powder were prepared as shown in Table 4. In this case, in view of the fact that a reduction process is mostly carried out due to emission of CO gas, 2 mol of C per 1 mol of ZrO₂ was used.

TABLE 4

| Target composition | Raw materials used (gram/batch) | | |
|---|---|---|---|
| (mol. %) | ZrO₂ | WC | C |
| W-36Zr-32ZrC | 9.672 | 12.5 | 2.828 |

The prepared mixture of materials was dry ground by means of a high-energy planetary mill using WC—Co balls at a rate of 250 rpm and a BPR of about 40:1 for about 20 hours and thermally treated in a vacuum at a temperature of about 1500° C. for 1 hour and underwent reduction and carbonization processes to prepare a powder.

FIG. 7 is a graph showing XRD analysis results of a W-68 mol. % ZrC_{0.47} powder prepared by performing reduction and carbonization at a temperature of about 1600° C. for about 1 hour.

The composition used in FIG. 7 may provide a stoichiometric carbide composition, such as W-68 mol. % ZrC_{0.47}, due to a reaction. In view of the fact that a ZrC peak occurred without a Zr peak as expected and had a high intensity, it was confirmed that stoichiometric ZrC_{X} in which a value x was close to 0.5 was formed.

This is because formation of ZrC or ZrC_{X} is more thermodynamically stable even in the above-described composition (W-68 mol. % ZrC_{0.47}). Based on Embodiment 3, it can be seen that a composite powder containing a stoichiometric carbide (or carbonitride) and solid-solution-phase carbide (or carbonitride) in various matrix phases may be prepared due to a reaction.

### Embodiment 4

To prepare a composite powder for a W-50 mol. % Zr(CN) heat-resistant structural material, WO₃, ZrO₂, and C powder were prepared as shown in Table 5. In this case, in view of the fact that a reduction process is mostly carried out due to emission of CO gas, a composition of prepared materials was determined such that 3 mol of C per 1 mol of WO₃ and 2.5 mol of C per 1 mol of ZrO₂ were used to form W—Zr(CN).

TABLE 5

| Target composition | Raw materials used (gram/batch) | | |
|---|---|---|---|
| (mol. %) | ZrO₂ | WO₃ | C |
| W-50Zr(CN) | 7.312 | 13.767 | 3.921 |

The prepared mixture of materials was dry ground by means of a high-energy planetary mill using WC—Co balls at a rate of 250 rpm and a BPR of about 40:1 for about 20 hours and thermally treated at a temperature of about 1500° C. for 2 hours while maintaining an N partial pressure of 30 Ton in a vacuum and underwent reduction and carbonization processes to prepare a composite powder.

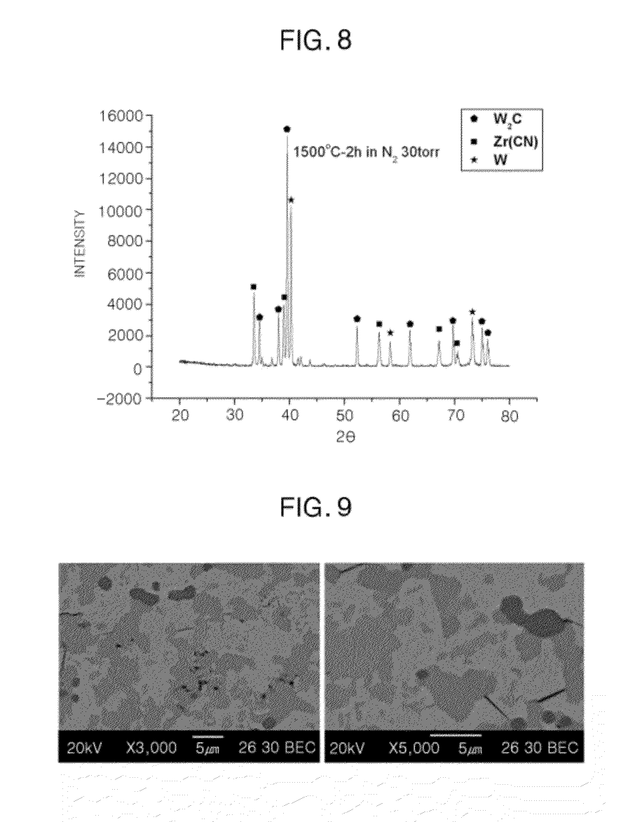

FIG. 8 is a graph showing XRD analysis results of W-50Zr(CN) prepared by performing reduction and carbonitridation at a temperature of about 1500° C. for about 2 hours.

Table 5 shows that Zr(CN) was formed between ZrC and ZrN. As shown in FIG. 8, W₂C was formed in addition to W-50Zr(CN). This seems to be due to the fact that, since a N partial pressure is higher than an appropriate partial pressure, surplus C formed W₂C. Furthermore, it can be seen that a W-W₂C—Zr(CN) composite powder may be prepared as needed using the above-described method.

### Embodiment 5

To prepare a composite powder for a Mo-30 mol. % ZrC heat-resistant structural material, MoO₃, ZrO₂, and C powder were prepared as shown in the following Table 6. In this case, in view of the fact that a reduction process is mostly carried out due to emission of CO gas, the amount of injected C was determined by calculating that 3 mol of C per 1 mol of MoO₃ and 3 mol of C per 1 mol of ZrO₂ were required.

TABLE 6

| Target composition | Raw materials used (gram/batch) | | |
|---|---|---|---|
| (mol. %) | ZrO₂ | MoO₃ | C |
| Mo-30ZrC | 6.38 | 17.40 | 6.22 |

The prepared mixture of materials was dry ground by means of a high-energy planetary mill using WC—Co balls at a rate of 250 rpm and a BPR of about 30:1 for about 20 hours and thermally treated in a vacuum at a temperature of about 1500° C. for 1 hour and underwent reduction and carbonization processes to prepare a composite powder for a structural material.

The prepared Mo-30 mol. % ZrC composite powder for the structural material was shaped and sintered at a temperature of about 2000° C. for about 1 hour under a pressure of about 10 MPa in a hot press.

FIG. 9 is a SEM image of a microstructure of a Mo-30 mol. % ZrC powder sintered body obtained by sintering a Mo-30 mol. % ZrC structural-material composite powder, which is prepared by performing reduction and carbonization at a temperature of about 1500° C. for 1 hour, and at a temperature of about 2000° C. for 1 hour under a pressure of about 10 MPa in a hot press.

From the XRD results of the present sample, it can be seen that a large amount of Mo₂C was generated in addition to Mo and ZrC. From the SEM results of FIG. 9, it can be observed that two accessory phases having different grayscales coexisted. When Mo was used as a matrix phase, a combination of ZrC seriously occurred so that a carbide having a particle size of about 5 μm or more was prepared and destruction caused by internal stress was observed.

While the disclosure has been shown and described with reference to m certain exemplary embodiments thereof, it will be understood by those skilled in the art that various changes in form and details may be made therein without departing from the spirit and scope of the disclosure as defined by the appended claims.

1. A composite powder for a structural material having a composition of M₁₋ₓ % M₂C, M₁₋ₓ % (M₂,M₁)C, M₁₋ₓ% M₂(CN), or M₁₋ₓ % (M₂,M₁)(CN),
wherein a matrix-phase metal M₁ is one selected from tungsten (W) and molybdenum (Mo) of the periodic table of the elements, an accessory-phase metal M₂ is one selected from the group consisting of Group-IV to Group-VI metals of the periodic table of the elements and forms a carbide or carbonitride having an average particle size of about 1 μm or less, and the matrix-phase metal M₁ and the accessory-phase metal M₂ coexist due to a reaction.

2. The composite powder of claim 1, which comprises a single metal phase M₁, which is W or Mo, and comprises at least two phases, which are carbides M₂C and (M₂,M₁)C or carbonitrides M₂(CN) and (M₂,M₁)(CN).

3. The composite powder of claim 1, wherein the metal M₁ is one selected from the group consisting of titanium (Ti), vanadium (V), chromium (Cr), zirconium (Zr), niobium (Nb), hafnium (Hf), and tantalum (Ta), and the other metal M₂ is one selected from Group-IV metals to Group-VI metals selected from the periodic table of the elements.

4. A method of preparing a composite powder for a structural material, comprising:
i) mixing or mixing and grinding at least one material selected from the group consisting of a single metal M₁, which is W or Mo, and an oxide, carbides and nitrides of the metal M₁, at least one material selected from the group consisting of at least one metal M₂ selected from the group consisting of Group-IV to Group-VI metal elements and an oxide and a nitride of the metal M₂, and C powder; and
ii) causing reduction and carbonization or reduction and carbonization by heating the mixture of step i).

5. The method of claim 4, wherein, in step i), the metal M₁ is selected from the group consisting of Ti, V, Cr, Zr, Nb, Hf, and Ta.

6. The method of claim 4, wherein, in step ii), the heating of the mixture is performed at a temperature of about 1100° C. to about 2200° C.

7. The method of claim 4, wherein, in step ii), the heating of the mixture is performed at a temperature of about 1300° C. to about 1700° C.

8. The method of claim 4, wherein, in step ii), the heating of the mixture is performed for about 0.5 hour to about 5 hours.

9. The method of claim 4, wherein, in step ii), the heating of the mixture is performed in the atmosphere of hydrogen (H2) or nitrogen (N2) or in a vacuum.

10. The method of claim 4, wherein the composite powder comprises the single metal phase M₁ and includes at least two phases, which are carbides M₂C and (M₂,M₂)C or carbonitrides M₂(CN) and (M₂,M₁)(CN).

11. The method of claim 4, wherein the carbide or carbonitride of the composite powder has an average particle size of about 1 μm or less.

12. A composite sintered body for a structural material, which is obtained by coupling a main-phase metal M₁ selected from W and Mo with an accessory-phase metal (M₂)-based carbide or carbonitride selected from Group-IV to Group-VI elements of the periodic table of the elements.

13. The composite sintered body of claim 12, which contains 60 to 95% by volume the main-phase metal M₁.

14. The composite sintered body of claim 12, wherein each of the main-phase metal M₁ and the accessory-phase metal M₂ is one selected from the group consisting of Ti, V, Cr, Zr, Nb, Mo, Hf, W, and Ta.

15. A method of preparing a composite sintered body for a structural material, the method comprising:
i) mixing or mixing and grinding at least one material selected from the group consisting of a single metal M₁ and an oxide, a carbide, and a nitride of the metal M₁, at least one material selected from the group consisting of at least one metal M₂ selected from the group consisting of Group-IV to Group-VI metals of the periodic table of the elements and an oxide and a nitride of the metal M₂, and C powder;
ii) causing reduction and carbonization or reduction and carbonitridation by heating the mixture of step i);
iii) mixing the powder obtained in step ii) with a powder of the metal M₁ as needed; and
iv) shaping and sintering the powder obtained in step ii) or step iii).

16. The method of claim 15, wherein the metal M₁ of step i) is one selected from the group consisting of Ti, V, Cr, Zr, Nb, Hf, and Ta.

17. The method of claim 15, wherein, in step ii), the heating of the mixture is performed at a temperature of about 1100° C. to 2200° C.

18. The method of claim 15, wherein, in step ii), the heating of the mixture is performed at a temperature of about 1300° C. to 1700° C.

19. The method of claim 15, wherein, in step ii), the heating of the mixture is performed for about 0.5 hour to about 5 hours.

20. The method of claim 15, wherein, in step ii), the heating of the mixture is performed in the atmosphere of H2 or N2 or in a vacuum.

21. The method of claim 15, wherein the composite powder obtained in step ii) comprises the single metal phase M₁ and includes at least two phases, which are carbides M₂C and (M₂,M₁)C or carbonitrides M₂(CN) and (M₂,M₁)(CN).

22. The method of claim 15, wherein, in step iii), a powder of the metal M₁ is added to and mixed with the composite powder obtained in step ii) according to needed properties and compositions.

23. The method of claim 15, wherein, in step iii), an additive selected from the group consisting of carbides, nitrides, and carbonitrides of one selected from Group-IV to Group-VI metals of the periodic table of the elements is further added to and mixed with the composite powder obtained in step ii) or step iii) according to needed properties and compositions.

24. The method of claim 15, wherein the sintering of the powder in step iv) is performed in the atmosphere of N2 or Argon (Ar) or in vacuum using a hot press process, a hot isostatic press (HIP) process, a gas pressure sintering (GPS) process, or a spark plasma sintering process at a temperature of about 1000° C. to about 2200° C. for about 0.5 hour to about 2 hours.

25. The method of claim 15, wherein the sintering of the powder in step iv) is performed under a pressure of about 0.1 MPa to 150 MPa.

26. The method of claim 24, wherein the sintering of the powder in step iv) is performed at a temperature of about 1400° C. to about 2200° C. for about 0.5 hour to about 2 hours after the powder is pre-sintered at a temperature of about 1700° C. or lower.
